(19) United States
(12) Patent Application Publication
(10) Pub. No.: US 2009/0059314 A1
(43) Pub. Date: Mar. 5, 2009

(54) Scanning method for scanning device communicating with computer

(75) Inventor: Chun-Chieh Liao, Hsinchu (TW)

Correspondence Address: BACON & THOMAS, PLLC, 625 SLATERS LANE, FOURTH FLOOR, ALEXANDRIA, VA, 22314-1176, US

(73) Assignee: AVISION INC., Hsinchu (TW)

(21) Appl. No.: 12/153,471

(22) Filed: May 20, 2008

(30) Foreign Application Priority Data
Aug. 28, 2007 (TW) 96131925

(51) Int. Cl. H04N 1/04

(52) U.S. Cl. 358/474

(57) ABSTRACT

A scanning method for a scanning device communicating with a computer is provided. The scanning method comprises the following steps: executing a scanning program of a computer to connect a scanning device to the computer; initiating a scanning operation by the scanning device; performing the scanning operation by the scanning device to produce a scan image corresponding to an original; and transmitting the scan image to the computer by the scanning device.

This application claims the benefit of Taiwan application Serial No. 96131925, filed Aug. 28, 2007, the subject matter of which is incorporated herein by reference.

### BACKGROUND OF THE INVENTION

1. Field of the Invention

The invention relates in general to a scanning method for a scanner, and more particularly to a scanning method for a scanner receiving communicating with a computer and used by multiple users.

2. Description of the Related Art

Computer peripheral industries have gained prosperity and grown tremendously in the recent years: in particular, the printer and the scanner industries are experiencing strong competition. Through modern network configuration, business entities find it convenient and cost-saving to share hardware or software resources. Normally, a conventional scanner is connected to a single computer via a transmission cable. However, with the increasing popularity of local area network (LAN), the scanner can now be connected to multiple computers via a network, and the use of scanner has advanced from one scanner being connected to one computer to one scanner being connected to multiple computers. The use and file retrieving method of a conventional scanner have two types, namely the one-way pull-type and the network push-type methods. The two types of methods are elaborated below.

Referring to FIG. 1, a flowchart of a conventional pull-type method is shown. Firstly, as indicated in step 101, a scanning program of a computer is executed to control a scanner connected to the computer. Next, as indicated in step 102, the user places an original onto a scan platform or on a paper tray of a document feeder of the scanner, dependent on the type of the scanner. Afterwards, as indicated in step 103, the user inputs parameters and commands through the user interface of the scanning program of the computer to control the scanner to scan and produce a scan image. Next, as indicated in step 104, the scanner transmits the scan image produced to the computer. Afterwards, as indicated in step 105, when the user desires to scan a second original, the user needs to repeat the above scanning operation to produce a second scan image.

According to the pull-type method, the user opens a scanning program at the computer end, places an original at the scanner end, goes back to the computer end to execute scanning to obtain a scan image, and goes back to pick up the original after the scanning is completed. Therefore, the user has to travel between the scanner and the computer twice. When there are plenty of originals to be scanned, the user has to travel back and forth even more frequently. Especially in an office environment, it is very common that multiple users or multiple computers share a scanner which is often not at the length of the user's arm, and the user would have to waste a lot of time in the step of placing and picking up originals.

Referring to FIG. 2, a flowchart of a conventional push-type method is shown. Firstly, as indicated in step 201, the user places an original onto a scan platform or on a paper tray of a document feeder of the scanner. Next, as indicated in step 202, the user instructs the scanner to scan the original and produce a scan image by inputting via the control panel of the scanner. Afterwards, as indicated in step 203, the scanner stores the scan image in a network server or in a folder of a network computer. Next, as indicated in step 204, the user accesses the network server through the computer to retrieve the scan image. Afterwards, as indicated in step 205, the scan image is downloaded to the computer from the network server.

According to the push-type method, after an original is scanned at the scanner end, the scan image is temporarily stored in a network space such as the network server. When the user retrieves the scan image, the user needs to start up an application program at the computer end. For example, the user retrieves the scan image stored in the network server via the local area network or through the Internet by using a file transport protocol (FTP) program. And, the user must know the file name of the scan image before retrieving data, which is very inconvenient. Besides, the management of network servers and the security of scan image data are crucial for network accessibility.

### SUMMARY OF THE INVENTION

The invention provides a scanning method for a scanning device communicating with a computer. The user can completes the scanning operation on the scanning device end and the scanning device sends back the scan image to the user's computer so as to reduce complicated scanning procedures. In particular, when the scanning device is connected to a network for use with other users, the user does not need to walk between computer and scanning device frequently, which saves user's time and at the same time increases work efficiency.

According to a first aspect of the present invention, a scanning method is provided. The scanning method comprises the following steps. First, executing a scanning program of a computer to connect a scanning device to the computer. Next, initiating a scanning operation by the scanning device and performing the scanning operation by the scanning device to produce a scan image corresponding to an original. Afterwards, transmitting the scan image to the computer by the scanning device.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a flowchart of a conventional pull-type method;

FIG. 2 (Prior Art) shows a flowchart of a conventional push-type method;

FIG. 3 shows a scanning device connected to a computer;

FIG. 4 shows a functional block diagram of the scanning device connected to the computer in FIG. 3;

FIG. 5 shows a flowchart of a scanning method according to a first embodiment of the invention;

FIG. 6 shows multiple scanning devices connected to a computer;

FIG. 7 shows a flowchart of a scanning method according to a second embodiment of the invention; and

FIG. 8 shows a scanning device connected to multiple computers.

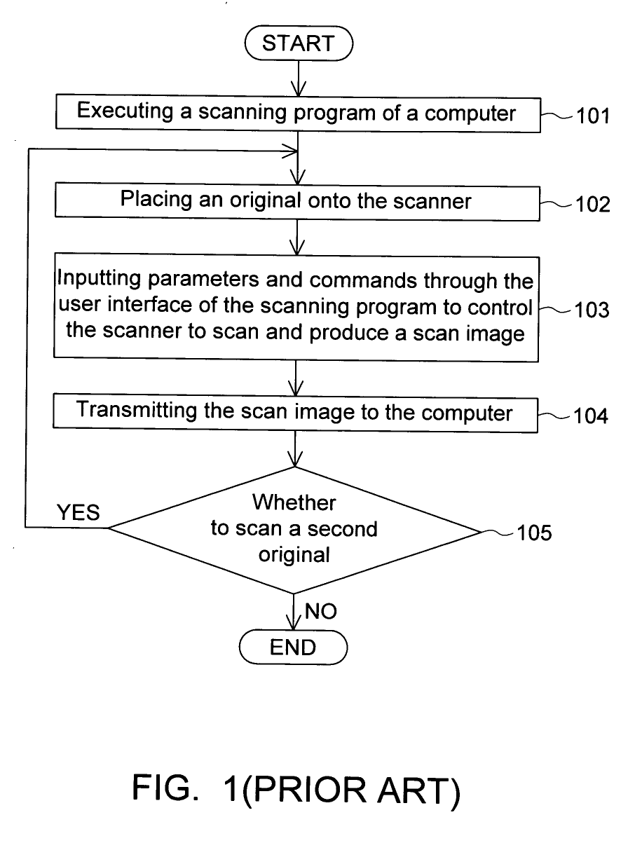

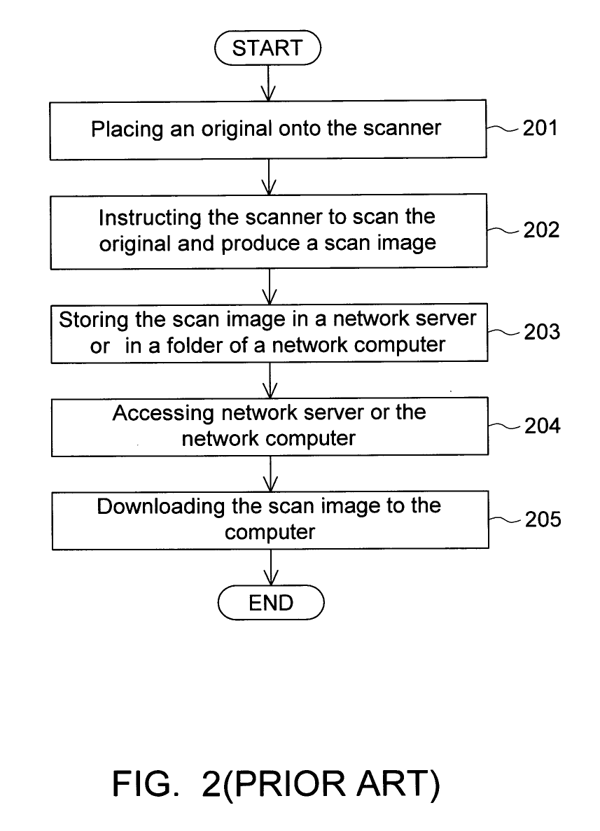

### DETAILED DESCRIPTION OF THE INVENTION

### First Embodiment

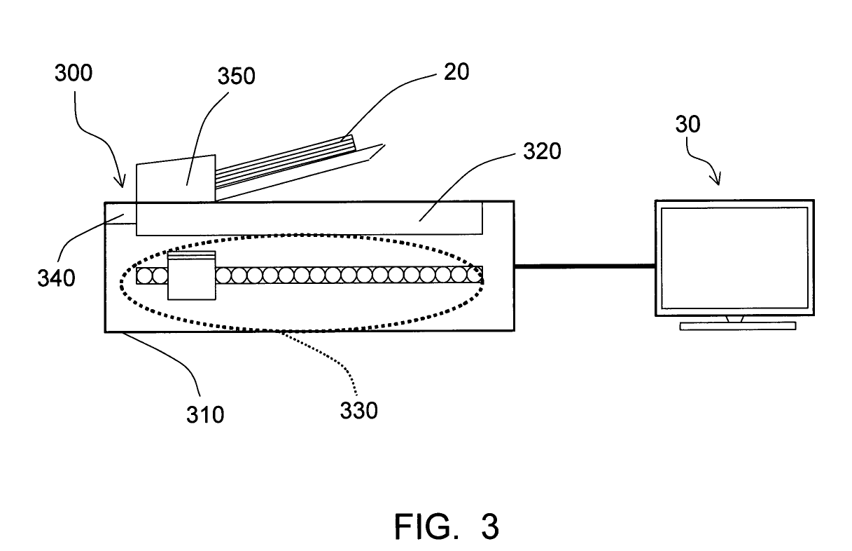

Referring to FIG. 3, a scanning device connected to a computer is shown. The scanning device 300 such as a scanner, a photocopier or a multi-function peripheral (MFP) is exemplified as a scanning device in the first embodiment of the present invention. In FIG. 3, a body 310 of the scanning device 300 is connected to a computer 30. The scan platform 320 is disposed on the body 310 for loading an original 20. The scanning module 330 is disposed inside the body 310 for scanning the original 20 and producing a scan image. The control panel 340 is for user to instruct the scanning device 300 to initiate a scanning operation. The control panel 340 such as a touch panel may further comprise a function of selecting a to-be-executed scanning job or canceling a to-be-executed scanning job. Besides, a sheet feeder 350 is disposed on the scan platform 320 for conveying the original 20 to a scan position, such that the original can be scanned by the scanning module 330.

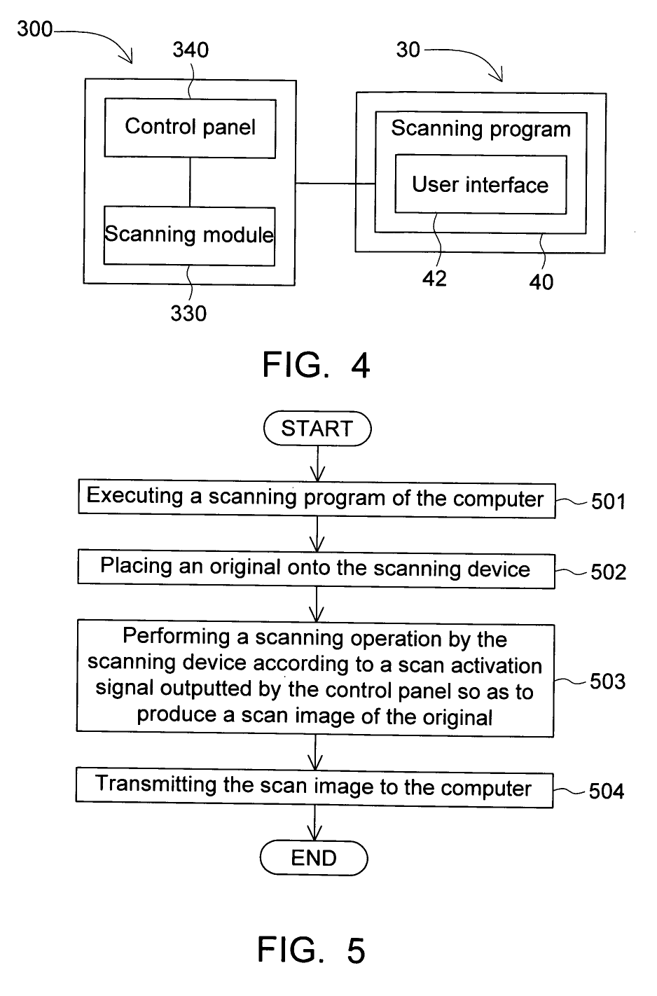

Referring to FIG. 4, a functional block diagram of the scanning device connected to the computer in FIG. 3 is shown. As indicated in FIG. 4, the computer 30 comprises a scanning program 40 for driving the scanning device 300. When the scanning program 40 is executed, the scanning device 300 and the computer 30 are connected for communication. The control panel 340 is electrically coupled to the scanning module 330. When the user instructs the scanning device 300 to perform the scanning operation via the control panel 340, a scan-activation signal is outputted to the computer by the scanning device 300, and the scanning program 40 controls the scanning device 300 to perform the scanning operation in response to the scan-activation signal so as to produce the scan image. Moreover, the scanning program 40 comprises a user interface 42 by which the user can alternately initiate the scanning operation through the scanning program 40 by inputting through the user interface 42, which enables the scanning module 330 to capture the image of the original 20.

Moreover, the scanning device 300 can also be connected to the computer 30 via interface standards, such as universal serial port (USB), IEEE1394 transmission port, or serial/parallel ports, or through local area network. In this embodiment of the present invention the connection is exemplified by a local area network (LAN). Alternately, the computer 30 and the scanning device 300 can be directly connected by a cable. However, anyone who is skilled in the technology of the invention will understand that the technology of the invention is not limited thereto. For example, the scanning device 300 can also be wirelessly connected to the computer 30, and the wireless connection is preferably a wireless local area network or Bluetooth protocol.

Detailed descriptions of the scanning method of the first embodiment of the present invention are made with reference to a flowchart in FIG. 5. Referring to FIG. 5, a flowchart of a scanning method according to a first embodiment of the invention is shown. Also, the numerals in FIG. 3 and FIG. 4 are referred. Firstly, as indicated in step 501, at the computer 30, a scanning program 40 corresponding to the scanning device 300 is executed so as to connect the scanning device 300 to the computer 30. Moreover, the scanning program 40 can reside in the operating system of the computer 30 to monitor the scanning device 300 and display to-be-executed scanning jobs stored in the scanning device 300 as well. The scanning program 40 comprises a user interface 42 for outputting a scanning control signal to the scanning device 300. The user interface 42 comprises at least one parameter setting option for setting the scanning parameter. The user interface 42 may include elements such as text input fields, tool bars or selection buttons for the user inputs.

Next, as indicated in step 502, at the scanning device 300 end, the user places an original 20 onto the sheet feeder 350 of the scanning device 300. The sheet feeder 350 will automatically feed the original 20 to the scan platform 320 for the scanning module 330 to scan the original 20 to produce a scan image.

Afterwards, as indicated in step 503, the scanning device 300 performs a scanning operation according to a scan-activation signal outputted by the control panel 340 so as to produce a scan image (not illustrated) of the original 20. In details, the scanning device 300 initiates the scanning operation to output a scan-activation signal to the computer 30, and the scanning program 40, in response to the scan-activation signal, controls the scanning device 300 to perform the scanning operation to produce a scan image.

Next, as indicated in step 504, the scan image is transmitted to the computer 30 by the scanning device 300. The user interface 42 of the scanning program 40 can also be used to execute some digital image processing functions, such as automatic clipping, batch storage, color restoring, color correction, resize, image distortion or file format conversion.

Moreover, a step of setting scanning parameters by using the user interface 42 of the scanning program 40 can be added to the method. Examples of scanning parameters include image resolution, image contrast, image brightness, Gamma value, color setting, black/white image setting and grey level image setting.

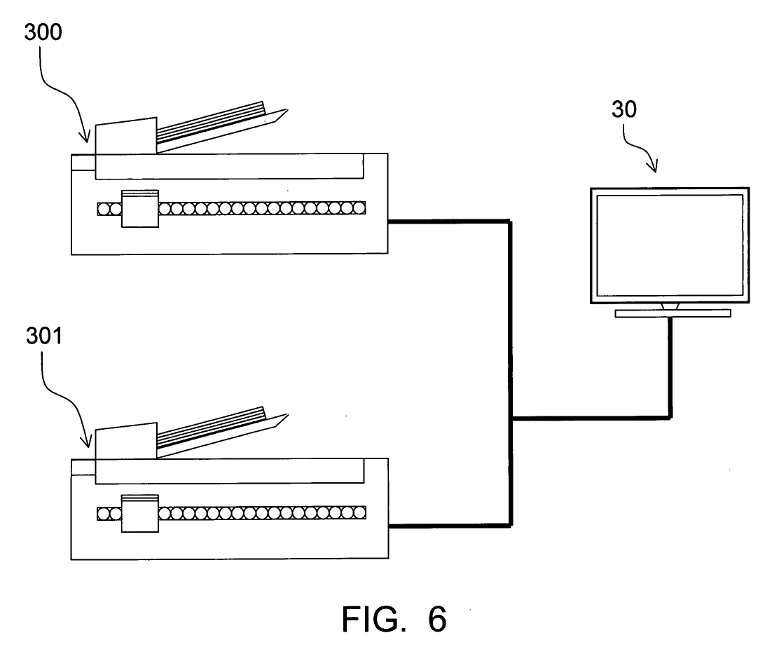

Furthermore, the scanning method of the invention is also applicable when multiple scanning devices are connected to a computer. Referring to FIG. 6, multiple scanning devices connected to a computer is shown. As indicated in FIG. 6, the computer 30 is connected to another scanning device 301 in addition to the scanning device 300. The computer 30 and the scanning devices 300 and 301 can be connected via wired or wireless connection. The computer 30 can control the scanning device 300 or the second scanning device 301 via the user interface 42 of the scanning program 40 to perform the scanning operation. In this configuration, one computer is connected to two scanning devices. However, in practical applications, one computer can be connected to more than two scanning devices, and the number of scanning devices to which a computer connected is not limited in the invention.

A simple scanning method is provided in this first embodiment of the present invention. The scanning method includes the steps of executing the scanning program 40 of the computer 30, loading an original 20 onto the scanning device 300 and initiating the scanning operation by the scanning device 300. Then, the scan image corresponding to the original 20 will be sent back to the computer 30 to complete the scanning operation. Provided the scanning program 40 resides in the computer 30, the user briefly places the original 20 onto the scanning device 300 and initiates the scanning operation at the scanning device 300. Sequentially, the scan image will be automatically sent back to the computer 30. Thus, to complete the scanning operation, the user only needs to travel between the computer 30 and the scanning device 300 once.

In the conventional pull-type scanning method, the original is scanned first and the scanning parameters are set by a scanning program in order to obtain better image quality. Moreover, the scan image of the original is directly sent back to the user's computer, hence ascertaining document security. In the conventional push-type scanning method, when there are many originals to be scanned, the originals can be scanned at the same time and retrieved by batch-download, hence avoiding reciprocal movements and repetitive operations and saving the user's time and energy. The scanning method of the first embodiment of the present invention incorporates the advantages of both the pull-type scanning and the push-type scanning methods.

### Second Embodiment

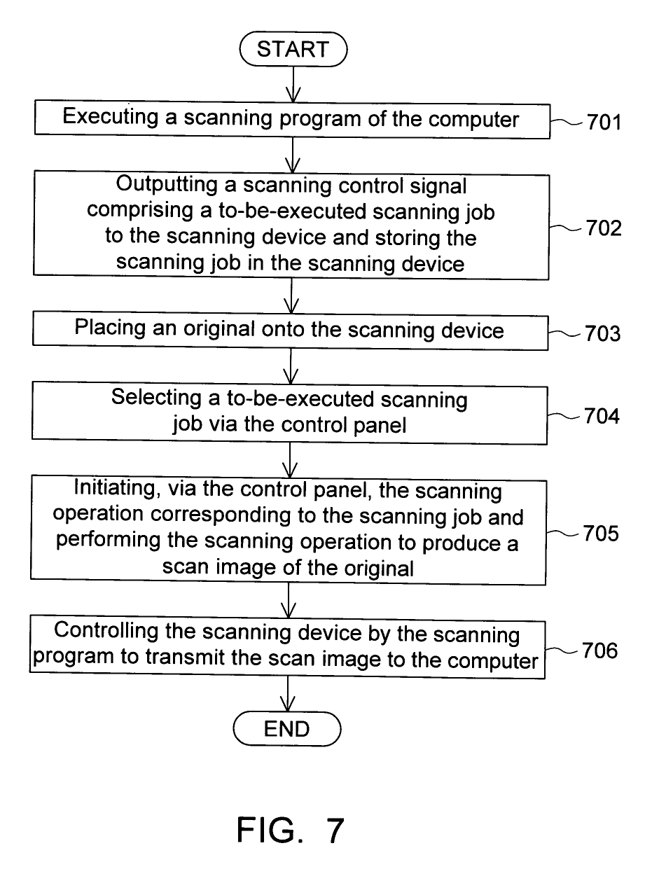

Referring to FIG. 7, a flowchart of a scanning method according to a second embodiment of the present invention is shown. The second embodiment differs from the first embodiment in the features that a scanning control signal comprising a to-be-executed scanning job is outputted by the computer, and the to-be-executed scanning job is stored in the scanning device. Only after the user has made selection on the scanning device will the scanning device start scanning. As for other elements similar to the first embodiment, the same numerals are used as in FIG. 3 and FIG. 4 and the function descriptions are not repeated here.

In the second embodiment, firstly, as indicated in step 701, a scanning program 40 corresponding to the scanning device 300 is executed on the computer 30 to connect the scanning device 300 to the computer 30.

Next, as indicated in step 702, the user may preset a scanning job via the user interface 42 of the scanning program 40, and the scanning program 40 outputs a scanning control signal comprising the scanning job to the scanning device 300. The scanning job is then stored in the scanning device 300.

Afterwards, as indicated in step 703, the user places an original 20 onto the sheet feeder 350 of the scanning device 300.

Next, as indicated in step 704, the user selects a scanning job via the control panel 340. In this embodiment of the present invention, the control panel is exemplified by a touch panel on which the scanning job is displayed for the user to select.

As indicated in step 705, the user initiates the scanning operation corresponding to the scanning job via the control panel 340 of the scanning device 300. Then, the scanning device 300 performs the scanning operation and produces a scan image corresponding to the original 20.

Next, as indicated in step 706, the scanning program 40 controls the scanning device 300 to transmit the scan image to the computer 30 to complete the scanning operation.

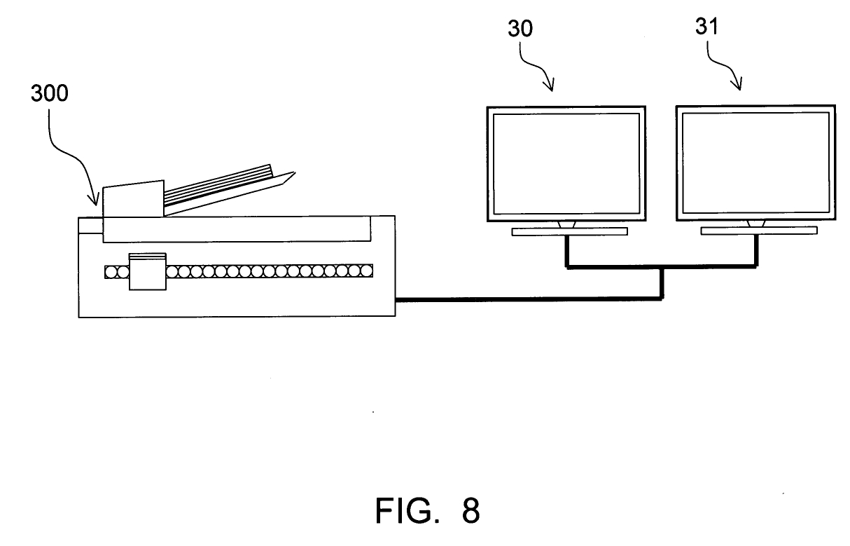

The features of the second embodiment of the present invention are enhanced when the scanning device is connected to multiple computers. Referring to FIG. 8, a scanning device connected to multiple computers is shown. The scanning device 300 is further connected to a second computer 31 in addition to the computer 30. The second computer 31 also includes the scanning program 40 which controls the scanning device 300. Like step 702, at the second computer 31, the scanning program 40 can output a second scanning control signal comprising a second to-be-executed scanning job, and the second to-be-executed scanning job is stored in the scanning device 300. In step 703, if the user of the second computer 31 places a second original onto the sheet feeder 350 of the scanning device 300, then, in step 704, the user of the second computer can select the second to-be-executed scanning job at the scanning device 300 and initiate a second scanning operation corresponding to the second to-be-executed job via the control panel 340, as indicated in step 705. The scanning device 300 performs the scanning operation to produce a second scan image corresponding to the second original. Afterwards, as indicated in step 706, the scanning device 300 transmits the second scan image to the second computer 31 to complete the scanning operation of the second computer 31. The scanning device 300 can store multiple scanning jobs from different computers, such that users of different computers can select the scanning jobs and instruct the scanning device 300 to perform the scanning operations corresponding to the scanning jobs selected.

In the second embodiment, the scanning program can be configured to be capable of monitoring a plurality of scanning devices at the same time, and the scanning device can be designed to be capable of storing a plurality of scanning jobs. Apart from executing the scanning operation, selecting the scanning jobs and canceling the scanning jobs, the control panel of the scanning device can be used to set scanning parameters and network environment.

In the above embodiments, a plurality of computers and scanning devices can be connected to each other via a local area network, the computer can select the scanning device, via the user interface of the scanning program, to execute a scanning operation, and the scanning device can, via a control panel, select a scanning job outputted from the computer to execute scanning. Apart from the characteristics of the first embodiment, the user can also complete the scanning easily by selecting a desired scanning job via the control panel. Despite some scanners are equipped with a scanning key by which the use can complete the scanning at a time, the generated scan image must be sent back to the user's computer via other programs or methods. Compared with the mechanism of such scanners, the above embodiments of the invention illustrate a scanning program which can control the scanning operation and the image data transmission under the circumstances that the scanning operation is initiated by the computer or by the scanning device.

The scanning device of the invention and the operating method using the same have the following advantages:

1. When scanning a classified document, the scan image can be directly transmitted to the user's computer without having to be stored in a public storage space, hence avoiding confidential information being divulged.

2. When a scanning operation is selected via a control panel and the scanning operation is initiated, the sheet feeder will automatically feed in sheets of documents one by one for batch scanning. Moreover, the scan image will be immediately sent back to the computer and there is no need to execute another program to retrieve the scan image. Thus, the operation is made easier, and the user does not need to travel between the computer and the scanning device repetitively, hence saving a large amount of time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanning method, comprising:
(a) executing a scanning program of a computer to connect a scanning device to the computer;
(b) initiating a scanning operation by the scanning device;
(c) performing the scanning operation by the scanning device to produce a scan image corresponding to an original; and
(d) transmitting the scan image to the computer by the scanning device.

2. The scanning method according to claim 1, wherein after the step (b), the method further comprises:
outputting a scan-activation signal to the computer by the scanning device;
wherein the scanning program controls the scanning device to perform the scanning operation in response to the scan-activation signal.

3. The scanning method according to claim 1, wherein the step (a) further comprises:
outputting a scanning control signal by the scanning program, wherein the scanning control signal comprises a to-be-executed scanning job; and
storing the to-be-executed scanning job in the scanning device.

4. The scanning method according to claim 3, wherein the scanning program comprises a user interface for instructing the computer to output the scanning control signal to the scanning device.

5. The scanning method according to claim 3, wherein before the step (b), the method further comprises:
selecting the to-be-executed scanning job by the scanning device.

6. The scanning method according to claim 1, wherein the scanning device is connected to a second computer, the scanning method further comprises:
executing a second scanning program of the second computer to control the scanning device;
initiating a second scanning operation by the scanning device;
performing the second scanning operation to produce a second scan image corresponding to a second original; and
transmitting the second scan image to the second computer by the scanning device.

7. The scanning method according to claim 6, wherein the step of executing the second scanning program further comprises:
outputting a second scanning control signal by the second scanning program, wherein the second scanning control signal comprises a second to-be-executed scanning job; and
storing the second scanning job in the scanning device.

8. The scanning method according to claim 7, wherein before the step of initiating the second scanning operation by the scanning device, the method further comprises:
selecting the second scanning job by the scanning device.

9. The scanning method according to claim 6, wherein the scanning device is connected to the computer and the second computer via a network.

10. The scanning method according to claim 1, wherein the step (d) comprises:
controlling the scanning device by the scanning program to transmit the scan image to the computer.

11. The scanning method according to claim 1, further comprising:
setting at least one scanning parameter of the scanning device.

12. The scanning method according to claim 11, wherein the scanning parameter is one of image resolution, image contrast, image brightness, Gamma value, color setting, black/white image setting and grey level image setting.

13. The scanning method according to claim 11, wherein the scanning program comprises a user interface comprising at least one parameter setting option for setting the scanning parameter.

14. The scanning method according to claim 1, wherein the scanning device is one of a scanner, a photocopier and a multi-function peripheral (MFP).
